(19) United States
(12) Patent Application Publication
(10) Pub. No.: US 2021/0113015 A1
(43) Pub. Date: Apr. 22, 2021

(54) MODULAR MOBILE GRILL AND ROTISSERIE SYSTEM

(71) Applicant: L&G Barbeque Grills LLC, Woburn, MA (US)

(72) Inventors: Leo Carayannopoulos, Winchester, MA (US); George Tsitsopoulos, Woburn, MA (US)

(21) Appl. No.: 16/657,930

(22) Filed: Oct. 18, 2019

(51) Int. Cl. A47J 37/07

(52) U.S. Cl. CPC A47J 37/0704; A47J 2037/0777; A47J 37/0786

(57) ABSTRACT

At least one aspect relates to a grill. The grill includes a first base, a first sidewall extending from the first base, a second base, a second sidewall that extends from the second base, a cavity formed by the first sidewall and the second sidewall above the first base and the second base, a rail receiver attached to at least one of the first base or the second base and opposite the cavity, a rail, a plurality of legs attached to at least one of the first base or the second base and opposite the cavity, and at least one pole attached to a first leg of the plurality of legs. When a force is applied, the second base receives the first base along a base axis, the second sidewall receives the first sidewall along a sidewall axis, and the rail receiver receives the rail along a rail axis.

### BACKGROUND

Grills and rotisseries are used in a wide variety of applications such as tailgating, family gatherings, personal cooking, and commercial cooking. Because there are so many uses for a grill, they come in many shapes, sizes, styles, and configurations. Some devices may be limited in configurability, making it difficult to transport or operate in different modes of operation.

### SUMMARY

At least one aspect relates to a grill. The grill includes a first base, a first sidewall extending from the first base, a second base, a second sidewall that extends from the second base, a cavity formed by the first sidewall and the second sidewall above the first base and the second base, a rail receiver attached to at least one of the first base or the second base and opposite the cavity, a rail, a plurality of legs attached to at least one of the first base or the second base and opposite the cavity, and at least one pole attached to a first leg of the plurality of legs. Where, the second base receives the first base along a base axis, the second sidewall receives the first sidewall along a sidewall axis, and the rail receiver receives the rail along a rail axis. The sidewall axis being within five degrees of parallel to the base axis and the rail axis being within five degrees of parallel to each of the base axis and the sidewall axis. Wherein, a force applied to the first sidewall causes the first base to move within the second base along the base axis, the first sidewall to move within the second sidewall along the sidewall axis, and the rail to move within the rail receiver along the rail axis.

Another aspect relates to a motor system. The motor system includes a housing, an electric motor, a first bracket, and a second bracket. The housing includes a receiver to receive a spit along a rotational axis. The electric motor rotates the receiver in a first direction of rotation about the rotational axis, the rotational axis defining a first plane axis perpendicular to the rotational axis, a second plane axis perpendicular to the rotational axis and the first plane axis, the first plane axis and second plane axis defining a first quadrant, a second quadrant, a third quadrant, and a fourth quadrant around the rotational axis in an order corresponding to the first direction of rotation. The first bracket extends from the housing towards a second direction from which the spit is received and is located in the first quadrant. The second bracket extends from the housing towards the second direction and is located in the third quadrant.

Another aspect relates to a rotisserie spit kit. The rotisserie spit kit includes a shaft, a base, an impact cover, a first tip, and a second tip. The shaft extends from a first end to a second end. The base extends from a third end configured to removably couple with the first end of the shaft to a fourth end. The impact cover can be removably coupled with the fourth end of the base and can have a greater diameter than the fourth end of the base. The first tip extends from a fifth tip end to removably couple with the second end of the shaft to a sixth tip end. The second tip extending from a seventh tip end configured to removably couple with the second end of the shaft to an eighth tip end. The eighth tip end can be more blunt than the sixth tip end.

### BRIEF DESCRIPTION OF THE DRAWINGS

FIG. 1 is a perspective view of a modular grilling and rotisserie system.

FIG. 2 is a perspective view of a grill that can be implemented in the modular grilling a rotisserie system of FIG. 1 in a non-extended configuration.

FIG. 3 is a bottom perspective view of the grill of FIG. 2 in an extended configuration.

FIG. 4 is a top perspective view of the grill of FIG. 2 in the extended configuration.

FIG. 5 is a side view of the grill of FIG. 2 in the extended configuration.

FIG. 6 is a perspective view of the grill of FIG. 2 in the non-extended configuration removably coupled to a roof assembly.

FIG. 7 is a perspective view of the grill of FIG. 2 in the non-extended configuration removably coupled to a first and a second back panel.

FIG. 8 is a perspective view of the grill of FIG. 2 in the extended configuration removably coupled to the roof assembly, the first and the second back panel, and a plurality of rotisserie holders.

FIG. 9 is a perspective view of the grill of FIG. 2 in the extended configuration removably coupled to a plurality of modular grill tables.

FIG. 10 is a bottom perspective view of the plurality of modular grill tables of FIG. 9.

FIG. 11 is a perspective view of a motor system that can be implemented in the modular grilling and rotisserie system of FIG. 1.

FIG. 12 is a side view of the motor system of FIG. 11.

FIG. 13 is a block diagram of the motor system of FIG. 11.

FIG. 14 is a perspective view of the motor system of FIG. 11 coupled to a rotisserie spit kit.

FIG. 15 is a perspective view of a rotisserie spit kit that can be implemented in the modular grill and rotisserie system of FIG. 1.

FIG. 16 is a perspective view of a base included in the rotisserie spit kit of FIG. 15.

FIG. 17 is a perspective view of a prep tip included in the rotisserie spit kit of FIG. 15.

FIG. 18 is a perspective view of a cook tip included in the rotisserie spit kit of FIG. 15.

### DETAILED DESCRIPTION

Before turning to the figures, which illustrate certain exemplary features in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a modular grill and rotisserie system can include a grill, a motor system, at least one modular grill table, and a rotisserie spit kit. Various components of the rotisserie system can be removably coupled to one another, enabling modularity for the system. For example, the mobile grill may be coupled to the motor system and the rotisserie spit kit without being coupled to the modular grill table. This creates a system that can be customizable to the configuration specified by the user. Furthermore, the entire grill and rotisserie system can be adjustable in size and arrangements. For example, the mobile grill may be extended, the rotisserie spit kit may have a cooking tip attached, and the modular grill table may be lowered to be below the mobile grill. The components of the system can be adjusted to respond to changing conditions while grilling. The system can be modified between rotisserie and grilling modes of operation, such as by implementing features relating to expandability (e.g., changing system size), ease of motor installation and operation (e.g., DC motor can be sideloaded onto the system to reduce likelihood of the hands of the user being exposed to very high temperatures from the heat source while also being powered by a portable power supply for situations where mains power is not available), and modular rotisserie spit components that can be quickly adapted to different steps in the rotisserie setup and cooking process. Various such features can enable the system to be used for grilling, kebab, small animal rotisserie (e.g., chicken), and large animal rotisserie (e.g., lamb, pig) modes of operation, while also being modular to allow the system to be stored in a compact form (e.g., many or all components can be stored in the grill box itself) for transport in the trunk of a small vehicle, and then rapidly assembled and adjusted to the appropriate mode of operation.

A grill system can include a first base, a first sidewall extending from the first base, a second base, a second sidewall extending from the second base, a rail, a slide mount, a plurality of legs, and a plurality of horizontal poles coupled to a plurality of legs. The portion of the grill used for cooking processes can be at least partially defined by the first base, the first sidewall, the second base, the second sidewall, and a cavity formed therein. The second base can receive the first base and the second sidewall can receive the first sidewall, which can enable the size of the mobile grill to be adjusted. The slide mount may be coupled to the second base on an opposite side of the base from the cavity and the rail may be coupled to the first base on an opposite side of the first base from the cavity. The slide mount can allow the rail to move linearly along a rail axis. The plurality of legs may support at least one of the first base or the second base. The plurality of horizontal poles can be coupled to a plurality of legs, and at least one of the poles may include a first and a second pole. The second pole can receive the first pole. The grill can include a roof assembly, the roof assembly protecting the grill from rain. The grill can include a first and a second back panel.

The grill can be expanded or contracted to adjust to a desired form factor. For example, the grill can be in a non-extended (e.g., closed) configuration, in which one or more points of contact between components of the grill, such as the first and second base, prevent further contraction of the grill. The grill can also be in an extended or at least partially extended state (or configuration). If the grill is in an extended configuration, a compressing force may be applied to the first sidewall. This may cause the second base to receive the first base, the second sidewall to receive the first sidewall, the rail to move linearly along the longitudinal axis (in the same direction as the force), and the second pole to receive the first pole. If the grill is in the non-extended configuration, a tensioning force may be applied to the first sidewall. This can cause the first base to separate from the second base, the first sidewall to separate from the second sidewall, the rail to move linearly along the rail axis (in the same direction as the force), and the first pole to separate from the second pole. Expanding or contracting the grill can enable the system to be manipulated between small animal rotisserie operation and large animal rotisserie operation.

The motor system can rotate a rotisserie spit. The motor system can include a housing that includes a receiver, an electric motor, and at least one pair of opposed brackets. The receiver can receive the rotisserie spit along a rotational axis. The electric motor may rotate the receiver in a first direction of rotation about the rotational axis. The opposed brackets can be laterally offset from the rotational axis and extended parallel to the rotational axis. When the motor system is activated, the brackets may prevent the motor system from spinning along the rotational axis thereby rotating the receiver and the rotisserie spit about the first direction of rotation. The receiver can support multiple size spits for various use cases (e.g., small animal rotisserie or large animal rotisserie).

The rotisserie spit kit can include a shaft, a base, a prep tip, and a cooking tip. The shaft may receive and support food and can include a plurality of threaded holes. The base may be removably coupled to the shaft and a rotisserie motor. The prep tip may be removably coupled to the shaft and end in a pointed edge, which can be used to puncture food. The cooking tip may be removably coupled to the shaft and can be used during cooking. For example, the shaft may be coupled to the prep tip. The prep tip can thereby be used to puncture food and the food may be received and supported by the shaft. The prep tip may then be removed and the cooking tip can be coupled to the shaft. The base may then be coupled to the shaft and the rotisserie motor. The rotisserie spit kit can include an impact cover that couples with the shaft to allow prep tip to be driven through the food without damaging other components of the spit kit, and then removed or switch with a different coupler to connect with the motor for being rotated by the motor.

The modular grill table can include a table top, a plurality of table legs, a plurality of horizontal poles, a plurality of attachment brackets, and at least one attachment bar. The table top may receive food and grilling accessories. The plurality of table legs can support the table top. The horizontal poles may provide a stabilizing force to the plurality of table legs. The plurality of attachment brackets can receive an attachment bar and allow the modular grill table to removably couple with other removable grill tables. The attachment bar may be received by a plurality of attachment brackets and can have a plurality of holes; one hole for each attachment bracket. The holes may receive a pin or fastener, removably coupling the attachment bar to an attachment bracket.

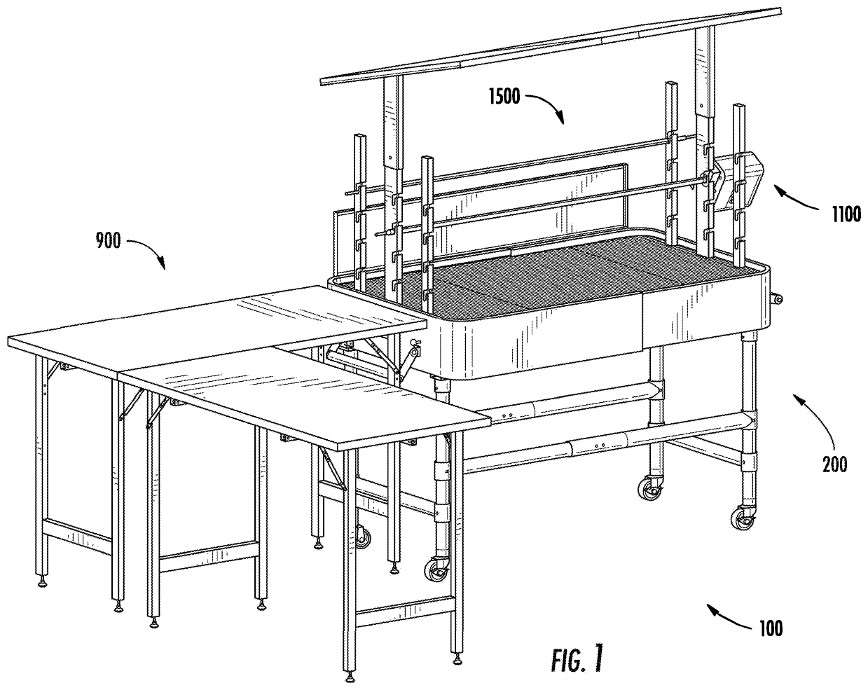

Referring now to FIG. 1, a perspective view of the modular grill and rotisserie system 100 is shown. The system 100 is shown to include a grill 200, a plurality of modular grill tables 900, a motor system 1100, and a rotisserie spit kit 1500. The system 100 may include a single modular grill table 900, a plurality of rotisserie spit kits 1500 and no motor system 1100. This is due to the modularity of the system 100. The modularity of system 100 enables various configurations to be enabled, such as by removably coupling multiple items to one another. This can enable a user to customize the mode of operation in which the system 100 is used, such as to change between small animal rotisserie and large or full animal rotisserie modes of operation.

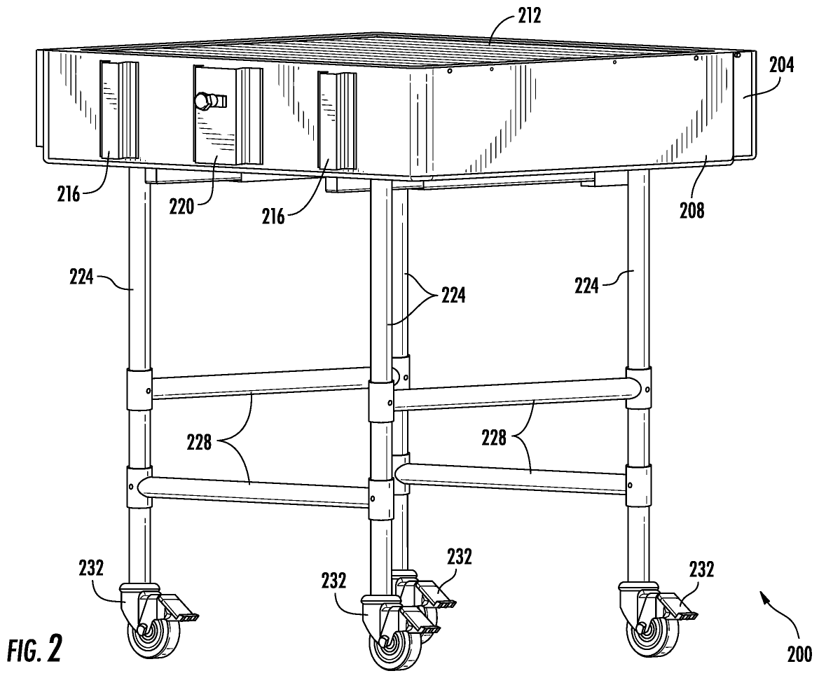

Referring now to FIGS. 2-4, the grill 200 may include a first sidewall 204, a second sidewall 208, a first base 304, a second base 308, and a cavity 404 formed therein. The grill 200 may be further defined by a longitudinal axis 416 that extends along the length of the first base 304 and the second base 308, a lateral axis 420 that extends along the width of the first base 304 and the second base 308, and a vertical axis 424 that extends along the height of the first sidewall 204 and the second sidewall 208. A base axis, sidewall axis, rail axis, and grate axis can be defined as axes extending from the center of their respective structures and within five degrees of parallel to the longitudinal axis 416 and the other axis. For example, the base axis can be located at the center of the first base 304 and the second base 308 and extends within five degrees of parallel to the longitudinal axis 416, the rail axis, the grate axis, and the sidewall axis. For example, the sidewall axis is located at the center of the first sidewall 204 and the second sidewall 208 and is within five degrees of parallel to the longitudinal axis 416, the rail axis, the grate axis, and the base axis. As shown, the sidewalls 208 and 204 may extend from the bases 308 and 304 respectively. The connection between the first sidewall 204 and the first base 304 can be a weld along the 90 degree seem formed by each. The connection can be a plurality of rivets. The connection between the second sidewall 208 and the second base 308 may be the same as the connection between the first sidewall 204 and the first base 304.

The second sidewall 208 can receive the first sidewall 204 along the sidewall axis. The second sidewall 208 may be slightly larger (e.g. 0.1 greater in height and 0.2 inches wider) than the first sidewall 204. Because it can be slightly larger, the first sidewall 204 can fit inside of the second sidewall 208. This allows for the length of the grill 200 (length along the longitudinal axis 416 between the first sidewall 204 and the second sidewall 208) to be adjustable. The second sidewall 208 can include at least one lip 408 that wraps around the first sidewall 204. The lip 408 does not prevent the first sidewall 204 from sliding into the second sidewall 208, but can prevent the first sidewall 204 from moving along the lateral axis 420 and the vertical axis 424. Both the first sidewall 204 and the second sidewall 208 may include at least one lip 408. The second sidewall 208 may contains bearings that allow the first sidewall 204 to linearly slide into the second sidewall 208 along the sidewall axis. The bearings may allow for a smooth motion. The bearings may be self-lubricated bearings. The second base 308 can receive the first base 304 along the base axis. The second base 308 may be slightly larger (e.g. 0.2 inches wider) and located below the first base 304 along the vertical axis 424. Because it may be slightly larger and located below the first base 304, the first base 304 can fit inside of the second base 308. This allows for the length of the grill 200 to be adjustable. The length of the grill 200 may be approximately 30 inches in the non-expanded configuration (e.g., greater than 20 inches and less than 40 inches; greater than 25 inches and less than 35 inches; greater than 28 inches and less than 32 inches) and adjust to 60 inches in the expanded configuration (e.g., greater than 50 inches and less than 70 inches; greater than 55 inches and less than 65 inches; greater than 58 inches and less than 62 inches).

The first base 304, second base 308, first sidewall 204, and second sidewall 208 may surround a controlled flame within the cavity 404. The flame may be produced by the burning of charcoal, wood, or combustible fluids. The grill 200 may be a charcoal grill (e.g. the main fuel source is charcoal). The cavity 404 can receive charcoal. The cavity 404 may receive wood pellets. The cavity 404 may receive a combustible fluid. The second base 308 may include an ash door 320. The ash door 320 may be used to clean the grill 200 of ash and debris such as charcoal or wood pellets. The ash door 320 can be selectively coupled to the second base 308 and moves between an open and a closed position. The ash door 320 can be pivotably coupled to the second base 308. The ash door 320 may include a locking mechanism that prevents it from being moved to the open position until the locking mechanism is released. The grill 200 can be a propane grill (e.g. the main fuel source is propane). The grill 200 may contain a variety of propane lines, burners, regulators, and other gas grill appliances related to producing a propane flame. The grill 200 may include a conversion kit that converts the mobile grill from a propane grill to a natural gas grill and vice versa. The grill 200 may be a hybrid grill, a grill that is both a charcoal grill and a propane grill (e.g. the fuel source may be charcoal or propane or both). The second base 308 may not include the ash door 320. As the ash door 320 provides a way for the user to remove ash, the grill 200 may include an alternative way for the user to remove ash from the cavity 404. For example, the second base 308 may include a gap between the second sidewall 208 to allow ash to be cleared from the cavity 404.

The grill 200 can include at least one cooking grate 212. The cooking grate 212 may be supported by at least one of the first sidewall 204 and the second sidewall 208. The cooking grate 212 may be supported by a plurality of the lips 408. The cooking grate 212 may be slightly smaller (e.g., 0.5 inches smaller in length and width) than the first sidewall 204 and the second sidewall 204. This allows food and other debris on the grate 212 to slide between the grate 212 and the first sidewall 204 or the second sidewall 208. The debris and food may then fall into the cavity 404, and can be removed from the grill 200 through the ash door 320. The grate 212 can receive food. The food may be raw or uncooked food. The food may be on a rotisserie spit kit 1500. The food may be in the form of kabobs on the rotisserie spit kit 1500. The cooking grate 212 may be a plurality of cooking grates 212. Within the plurality, each cooking grate 212 may receive food and be supported by a plurality of the lips 408. When the grill 200 is in the non-extended configuration it may include one cooking grate 212; when the grill is changed to the extended configuration it may include at least two cooking grates 212. When the grill 200 is in the non-extended configuration it may include two cooking grates 212; when the grill is changed to the extended configuration it may include at least three cooking grates 212. The cooking grate 212 may be at least one cooking grate 212 at a first height and at least one cooking grate 212 at a second height. The first grate 212 can be removably coupled to the first sidewall 204 and the second grate 212 can be removably coupled to the second sidewall 208 and receives the first grate 212 along the grate axis. The first grate 212 can be removably coupled to a first lip 408 that is coupled to the first sidewall 204 and the second grate 212 can be removably coupled to a second lip 408 attached to the second sidewall 208 and spaced far enough along the vertical axis 424 from the first lip 408 to fit the first grate 212. Therefore, when the second grate 212 receives the first grate 212 along the grate axis, the first grate may fit between the first lip 408 and second lip 408.

The cooking grate 212 may be sized to fit within the cavity 404. That is, the volume of the cooking grate 212 may be less than the volume of the cavity 404. More so, the cooking grate 212 in a non-specified orientation may be shorter in length along the longitudinal axis 416, the lateral axis 420 and the vertical axis 424 than the cavity 404. As the grate 212 may fit inside the cavity 404 when the grill 200 is being moved or stored, the horizontal grate 212 can be removed from the grill 200 and stored inside of the grill 200. This allows the grill 200 to take up less volume and fit inside smaller vehicles/storage areas.

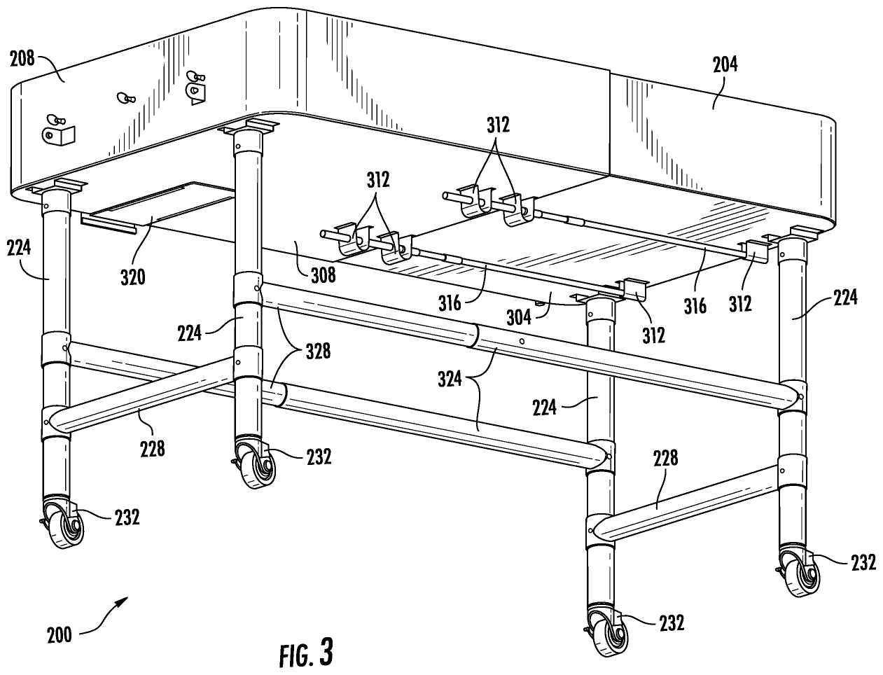

As shown in FIG. 3, the grill 200 may include at least one slide mount 312 and at least one rail 316. The slide mount 312 may be coupled to the second base 308 on an opposite side of the second base 308 from the cavity 404. The slide mount 312 may be fixedly coupled by a weld to the second base 308. The slide mount 312 may be removably coupled by fasteners to the second base 308. The slide mount may allow the rail 316 to move linearly along the rail axis. The slide mount 312 may receive the rail 316. The slide mount 312 can support the rail 316. The slide mount 312 may prevent the rail 316 from moving along the vertical axis 424 and the lateral axis 420. The rail 316 may be coupled to the first base 304 on an opposite side of the first base 304 from the cavity 404. The rail 316 may be removably coupled by a pin. The rail 316 may be removably coupled by a fastener. The rail 316 may be removably coupled to a mount by a pin or fastener, and the mount may be fixedly coupled to the first base 304. The mount may be fixedly coupled by a weld. The rail 316 may include a locking mechanism such as a hole that allows the rail 316 to be locked into place. The slide mount 312 can receive the rail 316. The holes of the rail 316, may allow a pin to fit inside the rail 316. The pin may then catch on the slide mount 312 and locks the entire grill 200 into a certain configuration. If in the extended configuration, the grill 200 may be locked into the extended configuration. If in the non-extended configuration, the grill 200 may be locked into the non-extended configuration. The pin may be removed, allowing the rail 316 to move along the longitudinal axis 416. When the rail 316 is locked into place, the second sidewall 208 and the second base 308 may be locked into place. The hole can receive a fastener inside the rail 316. The rail 316 may include a plurality of holes to receive a fastener. The pin may be a quick release pin that includes a plurality of detents to prevent the pin from being removed.

As depicted in FIG. 3, the grill 200 can include a plurality of legs 224, a plurality of wheels 232, and a plurality of horizontal poles 228. The legs 224 may be supporting at least one of the first base 304 and the second base 308. Each leg 224 may be coupled to at least one of the first base 304 and the second base 308. Each leg 224 may be removably coupled to at least one of the first base 304 and the second base 308. Each leg 224 may be removably coupled to a leg flange that is fixedly coupled to at least one of the first base 304 and the second base 308. Each leg 224 may be adjustable allowing for the grill 200 to gain or lose height along the vertical axis 424. Each leg of the plurality of legs 224 may be supported by a wheel of the plurality of wheels 232. The wheels 232 can allow the grill 200 to move locations. Each wheel 232 may be fixedly coupled to a leg 224. Each wheel 232 may be removably coupled to a leg 224 through a receiver of the wheel that allows rotation along the vertical axis 424. This can allow each wheel 232 to still rotate and move, while staying attached to each leg 224. Each wheel 232 may contain a locking mechanism. The locking mechanism may prevent each wheel 232 from moving, keeping it in the same location.

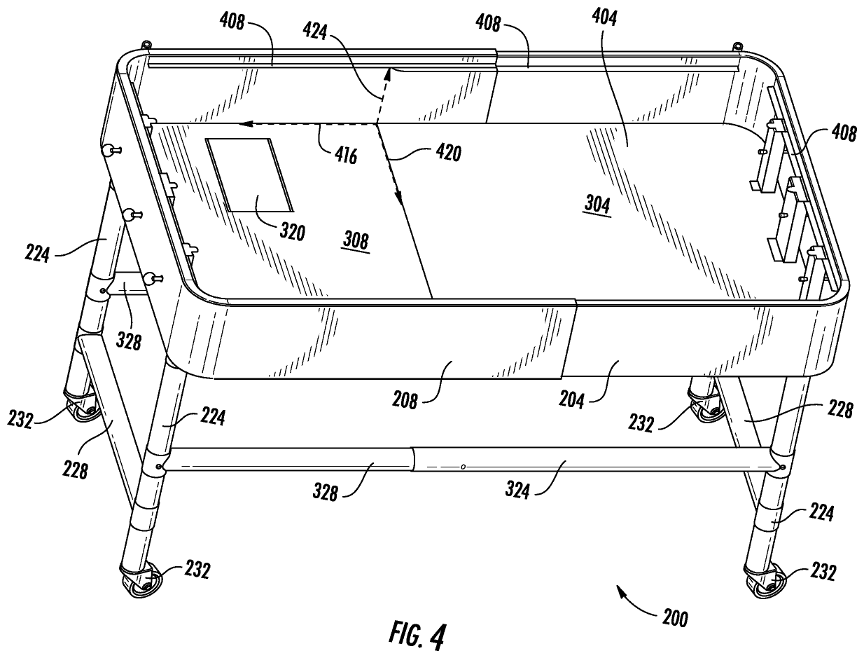

The plurality of horizontal poles 228 can be coupled to multiple legs 224. For example, each horizontal pole 228 may be coupled to two, three, four, five, or more legs 224. In some configurations, each horizontal pole 228 may be fixedly coupled to the plurality of legs 224 through a weld. In other configurations, each horizontal pole may be removably coupled to the plurality of legs through a coupling. The coupling, being a part of each leg 224, can receive a horizontal pole 228. In some configurations, each horizontal pole 228 may be received by the coupling and removably coupled by a fastener. In even other configurations, each horizontal pole 228 may prevent the plurality of legs 228 from moving in at least one of the longitudinal axis 416 and the lateral axis 420. By keeping the plurality of legs from moving in at least one of the longitudinal axis 416 axis and the lateral axis 420 axis, the legs 224 are under less stress, and only required to respond to the force from the weight of grill 200. This in turn allows for each leg 224 to support more weight and creates a stronger and sturdier grill 200. As best shown in FIG. 4, the plurality of horizontal poles 228 may include a first pole 324 and a second pole 328. The second pole 328 receiving the first pole 324. The second pole 328 may have a slightly larger radius (e.g. 0.1 inches larger) than the first pole 324. This allows the first pole 324 to slide inside of the second pole 328 and be received by the second pole 328. The second pole 328 may contain bearings that allow the first pole 324 to slide linearly parallel to at least one of the longitudinal axis 414 and the lateral axis 420.

At least one of the first pole 324 and the second pole 328 may include a locking mechanism such as a hole that allows the first pole 324 and the second pole 328 to be locked into place. The second pole 328 may receive the first pole 324. The hole of the second pole 328 can allow a pin or small metal obstruction to fit inside the second pole 328. The pin may then catch on the first pole 324 and lock the first pole 324 in place. This may lock the entire grill 200 in a certain configuration. If in the extended configuration, the grill 200 may be locked into the extended configuration. If in the non-extended configuration, the grill 200 may be locked into the non-extended configuration. The pin or obstruction may be removed, allowing the first pole 414 to move along at least one of the longitudinal axis 416 and the lateral axis 420. If the first pole 324 is locked into place, the second sidewall 208 and the second base 308 may be locked into place. The hole may receive a fastener inside the second pole 328. Both the first pole 324 and the second pole 412 may include a hole that receives a pin or a fastener. The hole may be a plurality of holes. The pin may be a quick release pin that includes a plurality of detents to prevent the pin from being removed. The mobile grill 200 may not include horizontal poles 228 along the longitudinal axis 416, which may allow the grill to easily move from the extended configuration to the non-extended configuration without the need to unlock the locking mechanism or adjust the horizontal poles 228. As the mobile grill 200 may not include the horizontal poles 228 along the longitudinal axis 416, the grill may not include the first pole 324 or the second pole 328. In this way, the remaining horizontal poles 228 along the lateral axis 420 do not include the first pole 324 or the second pole 328; instead the pole remaining horizontal poles 228 may be a single piece, as shown in FIG. 2.

The plurality of the horizontal poles 228 and the plurality of legs 224 may be sized to fit within the cavity 404. For example, the combined volume of the horizontal poles 228 and the legs 224 may be less than the volume of the cavity 404. The horizontal poles 228 and the legs 224 (e.g., in a non-specified orientation) can be shorter in length along the longitudinal axis 416, the lateral axis 420 and the vertical axis 424 than the cavity 404. As the legs 224 and horizontal poles 228 may fit inside the cavity 404, when the grill 200 is being moved or stored, the legs 224 and the horizontal poles 228 can be removed from the grill 200 and stored inside of the grill 200. This allows the grill 200 to take up less volume and fit inside smaller vehicles/storage areas. A cover may be provided to cover the grill 200, including during storage.

To adjust between the extended configuration and the non-extended configuration, the grill 200 requires a force to be applied. If in the extended configuration, a tensioning force may not cause any more extension, as the rail 316 may reach the maximum extension length. For example, once at the maximum length, the rail 316 cannot extend anymore and may hit a stopping mechanism such as a pin or a fastener. If in the extended configuration and a compressing force is applied to the first sidewall 204 and the second sidewall 208, the grill 200 may contract. The second base 308 may receive the first base 304, the second sidewall 208 may receive the first sidewall 204, the rail 316 may move linearly along the rail axis, the second grate 212 may receive the first grate 212, and the second pole 328 may receive the first pole 324. If in the non-extended configuration, a compressing force may not cause any more compression. One or more points of contact between main components such as the first base 304 and the second base 308 prevent any more compression. If in the non-extended configuration and a tensioning force is applied to the first sidewall 204 and the second sidewall 208, the grill 200 may extend. The first sidewall 204 may move apart from the second sidewall 208, the first base 304 may move apart from the second base 308, the rail 316 may move linearly along the rail axis (in the same direction as the force), the first grate 212 may move apart from the second grate 212, and the first pole 324 may move apart from the second pole 328. As the grill 200 can be adjustable in length along the longitudinal axis 416, the grill 200 can be used in a variety of sizes. The grill can be used in the non-extended configuration, the extended configuration, or any size in between. The grill 200 may be adjustable in length between 30 inches and 60 inches. Because the grill 200 may be adjustable in length, the grill 200 can be used as a large commercial grill and a small personal grill. Because the grill can be adjusted to a smaller size, the grill 200 can be stored or transported in a relatively smaller area. For example, the grill 200 can be transported in a car.

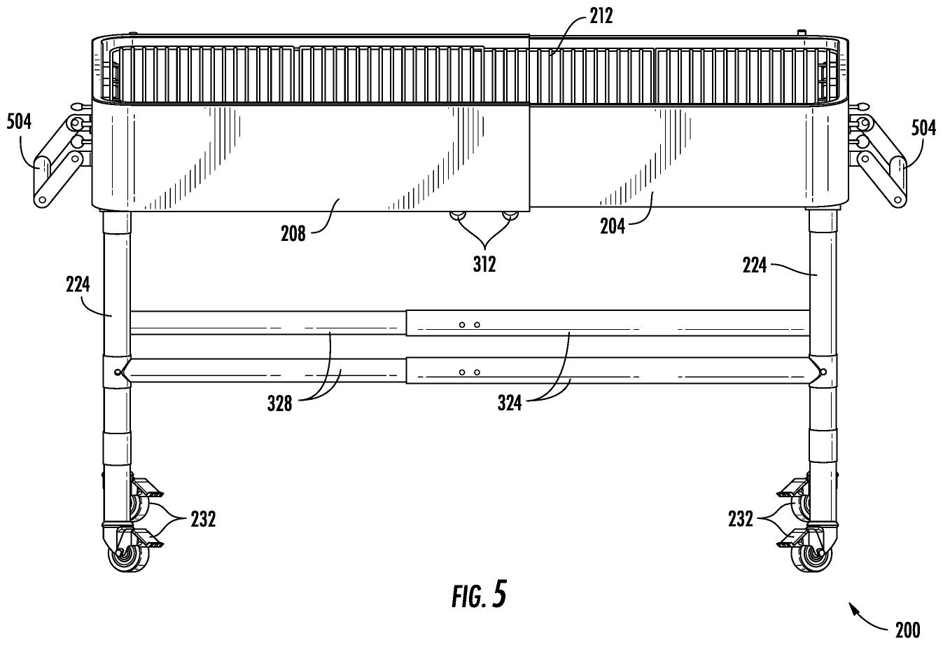

Referring now to FIG. 5, the grill 200 may include at least one handle 504. The handle 504 may be coupled to at least one of the first sidewall 204 and the second sidewall 208. The handle 504 may give the user of a grill 200 an easier grip to grip the grill 200. The handle 504 may be used to grip the grill 200 while moving it. The handle 504 may be used to apply a compressing or tensioning force to the grill in order to change the grill between an extended or non-extended configuration. The handle 504 may be fixedly coupled to at least one of the first sidewall 204 and the second sidewall 208. The handle 504 may be removably coupled to at least one of the first sidewall 204 and the second sidewall 208. The handle 504 may include holes that allow a pin to removably couple the handle 504 to at least one of the first sidewall 204 and the second sidewall 208. The grill 200 may include multiple handles 504. For example, a handle 504 may be coupled to the first sidewall 204 and the second sidewall 208.

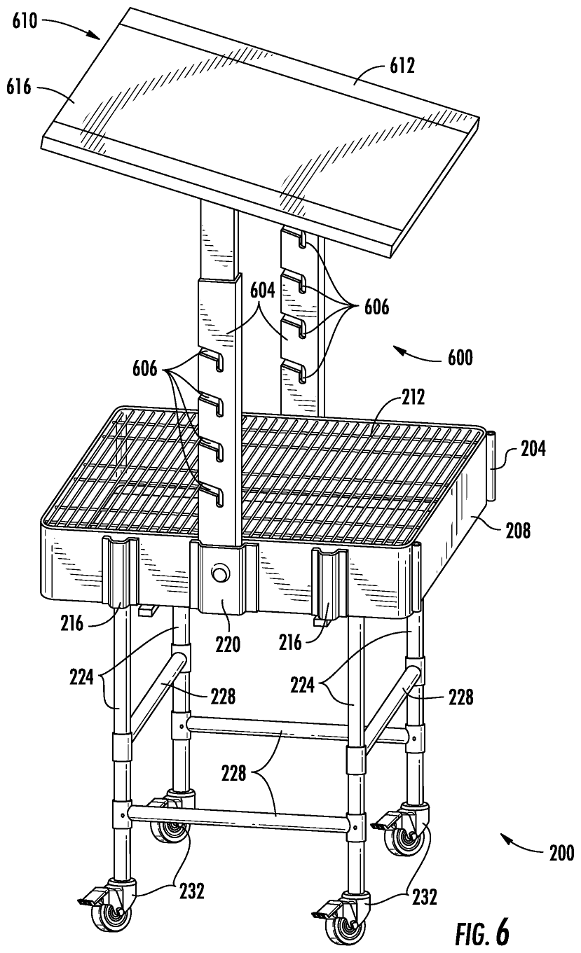

As depicted in FIG. 6, the grill 200 may include a first connector 216 and a second connector 220. If the handle 504 is removed, the first connector 216 or the second connector 220 may replace the handle 504. The first connector 216 may couple to at least one of the first sidewall 204 and the second sidewall 208. The first connector 216 may removably couple to at least one of the first sidewall 204 and the second sidewall 208. The first connector 216 may removably couple to at least one of a first side of the first sidewall 204, a second side of the sidewall 204, a first side of the second sidewall 208, and a second side of the second sidewall 208. That is, the first connector 216 may removably couple to either side of the first sidewall 204 and the second sidewall 204. By being removably coupled to either side, the mobile grill 200 can be customized to the configuration specified by the user. More so, the handle 504 can be coupled to one side of the first sidewall 204 or the second sidewall 208 and the first connector 216 can be coupled to the other side not occupied by the handle 504. The grill 200 may include a plurality of first connectors 216 that may be removably coupled to at least one of the first sidewall 204 and the second sidewall 208. The first connector 216 may include a hole that receives a pin or fastener. The pin or fastener may removably couple the first connector 216 to the first sidewall 204 or the second sidewall 208. The first connector 216 and the second connector 220 may be the same. The second connector 220 may operates the same as the first connector 216 but may be slightly larger.

The first connector 216 and the second connector 220 may be close to at least one of the first sidewall 204 and the second sidewall 208. The first connector 216 and the second connector 220 may be flush with at least one of the first sidewall 204 and the second sidewall 208. As the first connector 216 and the second connector 220 may be close with at least one of the first sidewall 204 and the second sidewall 208, the first connector 216 and the second connector 220 may be less likely to heat up and reach a high temperature. While grilling, a large problem is often that items close to the grill heat up and become hot to the touch. The first connector 216 and the second connector 220 may be therefore offset from the cavity 404 and close to the first sidewall 204 or the second sidewall 208. Therefore, the items received by the first connector 216 and the second connector 220 do not build up heat and can be touched or moved.

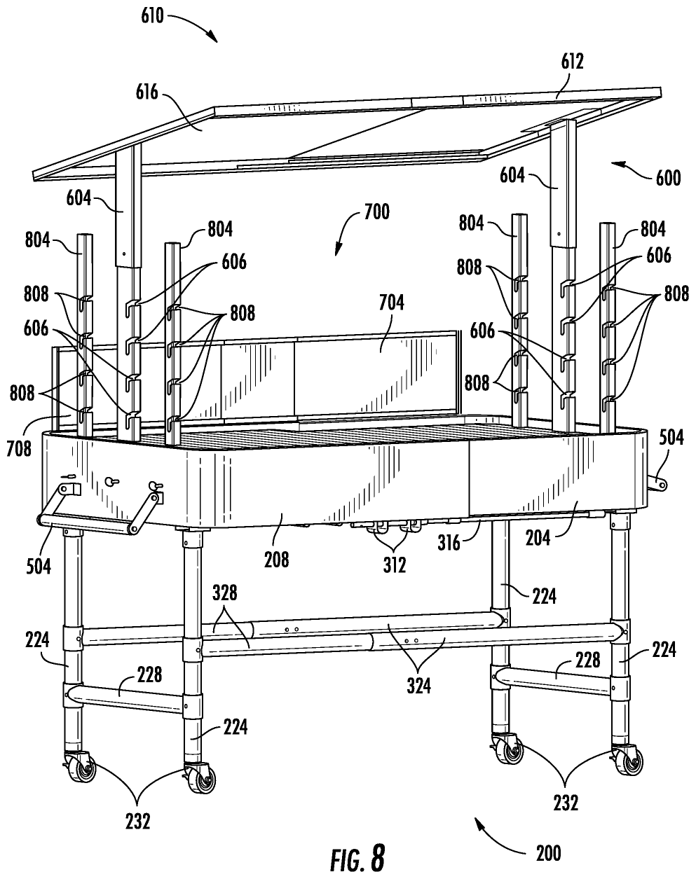

As depicted in FIGS. 6 and 8, the grill 200 may include a roof assembly 600. The roof assembly 600 may protect the grill from rain and including a roof 610 and a plurality of supports 604. The roof 610 may be angled relative to the base axis. By being angled relative to the base axis, the roof may catch and drain rain and snow to the ground. The roof 610 may entirely cover and protect the first base 304 and the second base 308. Because the roof 610 may catch rain and snow, the grill 200 and the food being cooked by the grill 200 may be protected from the water or cooling snow. This allows the temperature of the food being cooked to be consistent no matter the weather. The roof 610 may cover and protect the first base 304, the second base 308, and another rectangular area large enough for a person to fit (e.g. 5 ft×2 ft). By covering an area large enough for a person to fit, the user grilling on the grill 200 may be protected from the rain, snow, and other incremental weather.

The roof 610 may include a first roof panel 612 and a second roof panel 616. The second roof panel 616 can receive the first roof panel 612. The second roof panel 616 may be slightly larger (e.g. 0.1 greater in height and 0.2 inches wider) than the first roof panel 612. This allows for the length of the roof 610 and the grill 200 to be adjustable. In operation, the second roof panel 616 may receive the first roof panel 612 along a roof axis (the roof axis is an axis centered on the first roof panel 612 and the second roof panel 616 and within five degrees of parallel to the base axis). The second roof panel 616 may contain bearings that allow the first roof panel 612 to slide linearly along the roof axis and be received by the second roof panel 616. The length of the roof 610 may be 30″ in the non-extended configuration and may adjust to 60″ in the extended configuration. The roof 610 can allow the user to use the same roof for a variety of different applications, requires no additional adjustment to change from the non-extended to the extended configuration, and provides protection from the rain.

The roof assembly 600 can include the plurality of supports 604. The supports 604 may be coupled to and support the roof 610. The supports 604 may be pivotably coupled to the roof 610, allowing for the roof 610 to rotate. The supports 604 may be pivotably coupled to the roof 610, allowing for the roof 610 to rotate with respect to the longitudinal axis 416. The supports 604 may be fixedly coupled to the roof 610 by a weld. The plurality of supports 604 may be a plurality of opposed supports 604. The supports 604 may be opposed along the longitudinal axis 416. Each support of the plurality of supports 604 may include a plurality of slots 606. The slots configured to receive and hold one end of a rotisserie spit such as the rotisserie spit kit 1500. Each slot of the plurality of slots 606 may be angled downwards. By angling the slots 606 downwards, a rotisserie spit placed in the slots naturally stays in the slots 606 due to gravity and does not jostle out during operation. This provides stability to the rotisserie during cooking.

The supports 604 may have a first support end and second support end. The first support end may be removably coupled with the first sidewall 204 or the second sidewall 208 and extending to the second support end coupled to the roof 610. The second support end may couple with the at least one of first roof panel 612 and the second roof panel 616. The first support end may be removably coupled with the second connector 220. The first support end may include a hole that receives a pin or fastener. The pin or fastener may removably couple the first support end with the second connector 220. The pin or fastener may locks the first support end in place and therefore the roof assembly 600 in place. The supports 604 may be partially received by bearings inside of the second connector 220. Each support 604 may be close to the first sidewall 204 or the second sidewall 208. Each support 604 may be flush with the first sidewall 204 or the second sidewall 208. Because each support 604 may be close to the first sidewall 204 or the second sidewall 208 and away from the cavity 404, each support 604 do not become as hot as if they were closer to the cavity 404.

The supports 604 may fit inside of the cavity 404. That is, the supports 604 volume may be less than the volume of the cavity 404. More so, the supports 604 in a non-specified orientation may be shorter in length along the longitudinal axis 416, the lateral axis 420 and the vertical axis 424 than the cavity 404. As the supports 604 may fit inside the cavity 404, when the grill 200 is being moved or stored, the support 604 can be removed from the grill 200 and stored inside of the grill 200. This allows the grill 200 to take up less volume and fit inside smaller vehicles/storage areas. The roof assembly 600 may fit inside of the cavity 404.

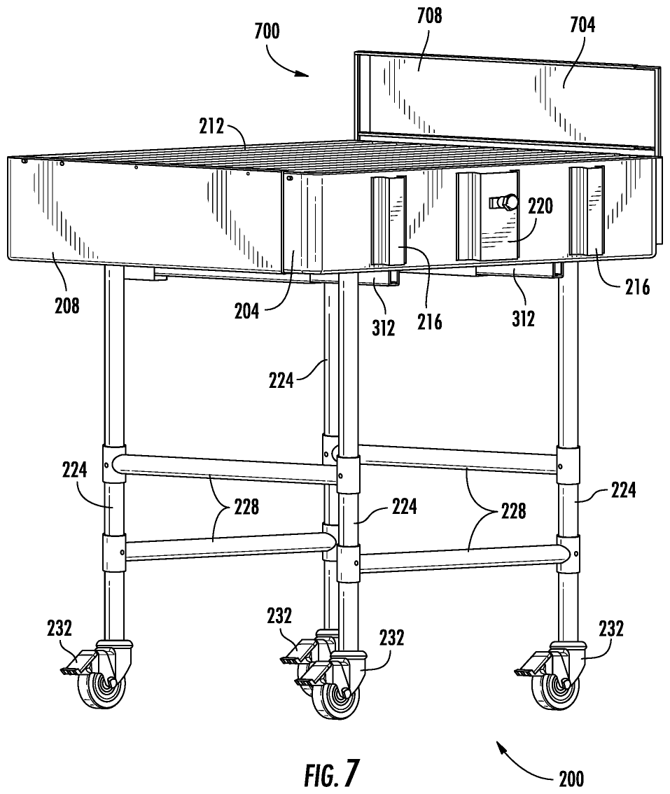

As depicted in FIGS. 7 and 8, the grill 200 may include a back panel assembly 700. The back panel assembly 700 may be removably coupled to the first sidewall 204 and the second sidewall 208. The back panel assembly 700 may include the first back panel 704 and the second back panel 708. The first back panel 704 may be removably coupled to the first sidewall 204 and the second back panel 708 removably coupled to the second sidewall 208. The first back panel 704 and the second back panel 708 may include a bar that removably couples to a receiver, which may have various form factors (e.g., square, circular). The first sidewall 204 and the second sidewall 208 may include a receiver that receives the bar. The first back panel 704 may be removably coupled to the second back panel 708. By being removably coupled, the back panel assembly 700 can be removed from the grill 200 and be broken down.

The back panel assembly 700 may be sized to fit inside the cavity 404. That is, the back panel assembly 700 has a volume that may be less than the volume of the cavity 404. More so, the back panel assembly 700 in a non-specified orientation may be shorter in length along the longitudinal axis 416, the lateral axis 420 and the vertical axis 424. As the back panel assembly 700 may fit inside the cavity 404, when the grill 200 is being moved or stored, the back panel assembly 700 can be removed from the grill 200 and stored inside of the grill 200. This allows the grill 200 to take up less volume and fit inside smaller vehicles/storage areas. The back panel assembly 700 may be broken into components (the first back panel 704 and the second back panel 708) before it fits inside the cavity 404. The back panel assembly 700 can retain heat to improve cooking efficiency and control over cooking by the user, while also functioning as a wind deflector and splash guard.

When removably coupled to the first sidewall 204 and the second sidewall 208, the back panel assembly 700 may protect items or people behind the grill (items on the same side of the grill 200 as the back panel assembly 700) from food debris and grease that pops or splatters during grilling. As with the first sidewall 204 and the second sidewall 208, the second back panel 708 may receive the first back panel 704; allowing for length of the grill 200 and the back panel assembly 700 (distance along the longitudinal axis 416) to be adjustable. The back panel 708 may include bearings that allow the first back panel 704 to slide linearly within five degrees of the longitudinal axis 416 and be received by the second back panel 708. The second back panel 708 may receive the first back panel along a back panel axis. The bearings may be self-lubricated bearings. The bearings may not allow the first back panel 704 to move along the lateral axis 420 or the vertical axis 424. The length of the back panel assembly 700 (total length along the longitudinal axis 416) may be adjustable between 30 inches and 60 inches.

Turning now to FIG. 8, the grill 200 may include a plurality of rotisserie holders (also referred to as supports) 804. Each rotisserie holder of the plurality of rotisserie holders 804, can be removably coupled to at least one of the first sidewall 204 and the second sidewall 208. The plurality of rotisserie holders 804 may be a pair of opposed (opposed along the longitudinal axis 416 or the base axis) rotisserie holders 804 removably coupled to the first sidewall 204 and the second sidewall 208. Each rotisserie holder 804 may be identical to the support 604. That is, each rotisserie holder 804 may have the same height, width, and length as the support 604. As shown, each rotisserie holder 804 may include a plurality of slots 808. The slots 808 may receive and hold one end of a rotisserie spit such as the rotisserie spit kit 1500. Each slot of the plurality of slots 808 may be angled downwards. By angling the slots 808 downwards, a rotisserie spit placed in the slots naturally stays in the slots 808 due to gravity and does not jostle out during operation. This provides stability to the rotisserie spit during cooking. Each slot 808 may be identical to each slot 606.

Each rotisserie holder 804 may have a first support end and second support end. The first support end may be removably coupled with the first sidewall 204 or the second sidewall 208 and extend to the second support end. The first support end may removably couple with the first connector 216. The first support end may include a hole that receives a pin or fastener. The pin or fastener can removably couple the first support end with the first connector 216. The pin or fastener may lock the first support end in place and therefore the rotisserie holder 804 in place. The rotisserie holders 804 may be partially received by bearings inside of the first connectors 216. Each rotisserie holder 804 may be close to the first sidewall 204 or the second sidewall 208. Each rotisserie holder 804 may be flush with the first sidewall 204 or the second sidewall 208. Because each rotisserie holder 804 may be close to the first sidewall 204 or the second sidewall 208 and away from the cavity 404, each rotisserie holder 804 does not becomes less hot than if they were close to the cavity 404.

The rotisserie holders 804 may be sized to fit inside the cavity 404. That is, the combined volume of the rotisserie holders 804 may be less than the volume of the cavity 404. More so, the rotisserie holder 804 in a non-specified orientation may be shorter in length along the longitudinal axis 416, the lateral axis 420 and the vertical axis 424. As the rotisserie holders 804 may fit inside the cavity 404, when the grill 200 is being moved or stored, the rotisserie holders 804 can be removed from the grill 200 and stored inside of the grill 200. This allows the grill 200 to take up less volume and fit inside smaller vehicles/storage areas.

Because the plurality of legs 224, the roof assembly 600, the back panel assembly 700, and the rotisserie holders 804 may be removably coupled to at least one of the first sidewall 204, the first base 304, the second sidewall 208, or second base 308, the grill 200 is modular. As stated previously, many grills have a specified purpose (e.g. rotisserie, mobile grill, commercial grill, etc.). The grill 200 though can be adjusted to a variety of different purposes. The grill 200 can be adjusted small enough to be easily moved (i.e. fit in the back seat of a sedan), can be adjusted to a large grill, can be used as a rotisserie (by removably coupling the roof assembly 600 and rotisserie holders 804), and can protect a user from incremental weather. This provides a large amount of utility in the grill 200. The legs 224, the back panel assembly 700, the rotisserie holders 804, the grate 212, and the supports 604 may be sized to fit inside the cavity 404. That is, the combined volume of the legs 224, the back panel assembly 700, the rotisserie holders 804, the grate 212, and the supports 604 may be less than the volume of the cavity 404. More so, the combined length of the legs 224, the back panel assembly 700, the rotisserie holders 804, the grate 212, and the supports 604 in a non-specified orientation may be shorter in length along the longitudinal axis 416, the lateral axis 420, and the vertical axis 424. The legs 224, the back panel assembly 700, the rotisserie holders 804, the grate 212, and the supports 604 may be in the non-extended configuration for each item to fit inside the cavity 404. As the referenced items may fit inside the cavity 404, when the grill 200 is being moved or stored, the items can be removed from the grill 200 and stored inside of the grill 200. This allows the grill 200 to take up less volume and fit inside smaller vehicles/storage areas.

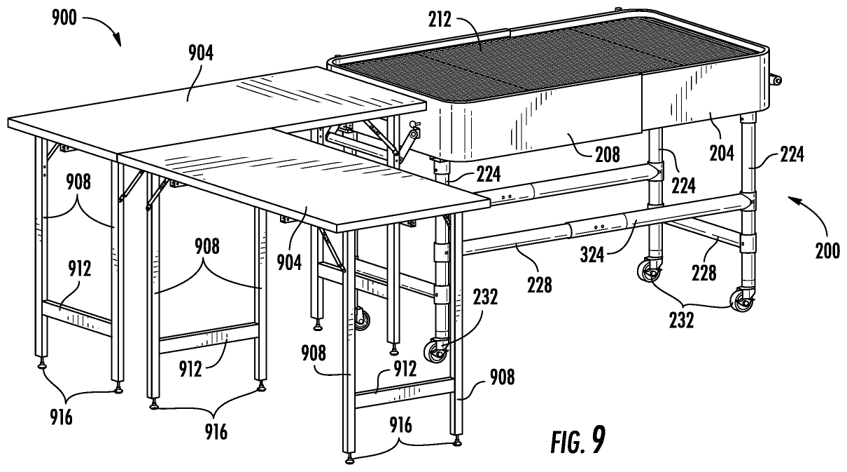

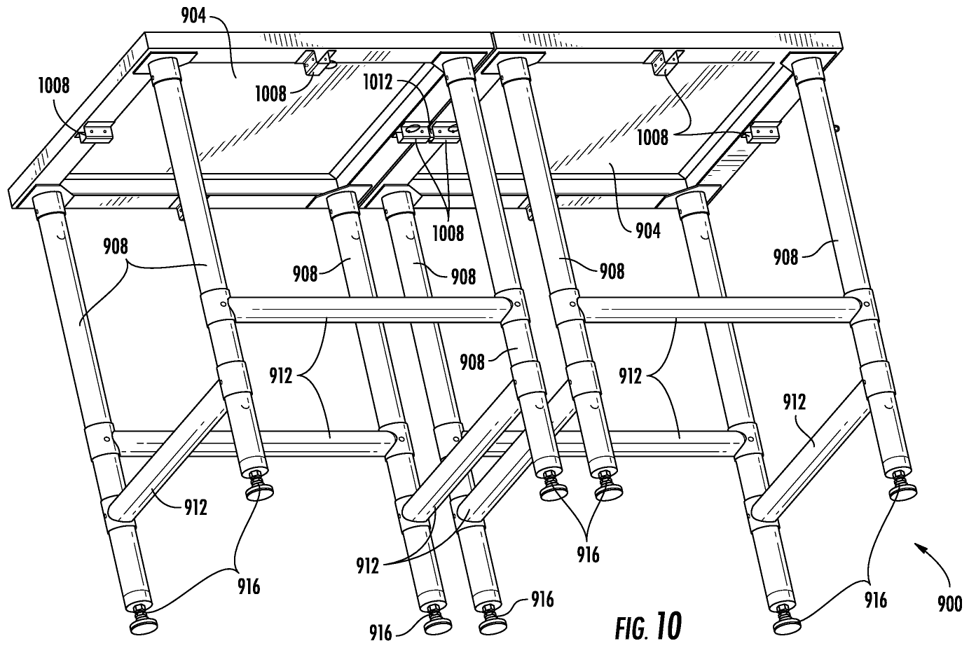

Referring now to FIGS. 9-10, the modular grill table 900 may include a table top 904, a plurality of table legs 908, a plurality of horizontal poles 912, and a plurality of levelling mounts 916. The table top 904 may be coupled to the plurality of table legs 908 and can receive food or grilling accessories. The table top 904 may be a rectangular table top as shown in FIG. 9. With the rectangular table top, the first side may be longer than the second side. The table top 904 may be a square table top as shown in FIG. 10, where the first side and the second side are the same size. The length of at least one side of the table top 904 may be the same length as the width (length of the first base 304 along the lateral axis) of the grill 200.

As depicted in FIG. 10, the table top 904 may be supported by and coupled to the plurality of table legs 908. The table legs 908 can be removably coupled to the table top 904. Each table leg 908 may be removably coupled to a leg flange that is fixedly coupled to the table top 904. Each table leg 908 can include a detent that fits into a hole of the leg flange. The detent may then be received through the hole and prevent each table leg 908 from moving. Each table leg 908 may include a hole that receives a pin or fastener. The pin or fastener may removably couple the table leg 908 with the leg flange. Each table leg 908 may include a levelling mount 916. The levelling mount 916 can allow the height of the modular grill table 900 to be adjustable. The levelling mount 916 may include a bolt that can be turned to raise or lower the height of the modular grill table 900. The levelling mount 916 may be used to level the table top 904 (i.e. make the table top 1016 parallel to the ground).

The plurality of horizontal poles 912 may be coupled to multiple table legs 908. Each horizontal pole 912 may be coupled to 2, 3, 4, 5, etc. table legs 908. In some configurations, each horizontal pole 912 may be fixedly coupled to the plurality of table legs 908 through a weld. In other configurations, each horizontal pole may be removably coupled to the plurality of legs through a coupling. The coupling, being a part of each table leg 908 can receive a horizontal pole 912. In some configurations, each horizontal pole 912 may be received by the coupling and removably coupled by a fastener.

The modular grill table 900 may include a plurality of attachment brackets 1008 and at least one attachment bar 1012. There may be two opposed attachment brackets 1008. There may be four attachment brackets 1008, one on each side of the table top 904. The attachment brackets 1008 may be located on each side of the table top 904 in the center of the side. The attachment brackets 1008 may include at least one hole. The holes may receive a pin or fastener. Each attachment bracket 1008 may receive the attachment bar 1012. The attachment bar 1012 may be a metal bar that attaches the modular grill table 900 to other modular grill tables. The attachment bar 1012 may include a plurality of holes. The holes may receive a pin or fastener. To attach the modular grill table 900 to another modular grill table, one bracket of the plurality of attachment brackets 1008 may receive the attachment bar 1012. A pin may be received through the hole of the attachment bracket 1008 and the attachment bar 1012. The attachment bar 1012 may then be received on an opposite end from the modular grill table 900 by another modular grill table's attachment bracket. A pin can then be received by another hole of the attachment bar 1012 and the other attachment brackets hole. This may selectively lock the modular grill table 900 to another modular grill table. Because the attachment bracket 1008 and the attachment bar 1012 allow the modular grill table 900 to attach to other grill tables, the modular grill table 900 can be used to create a custom grilling configuration. The custom configuration may help be used to serve customers, hold food, or other food preparation materials

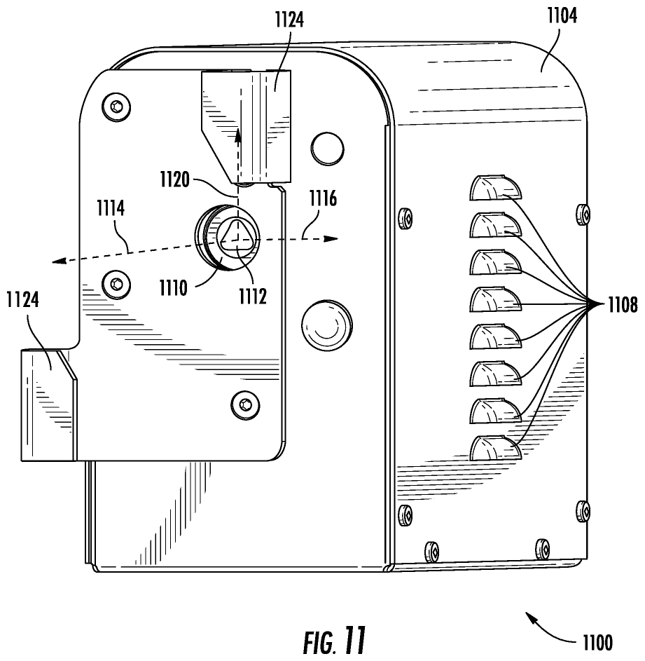

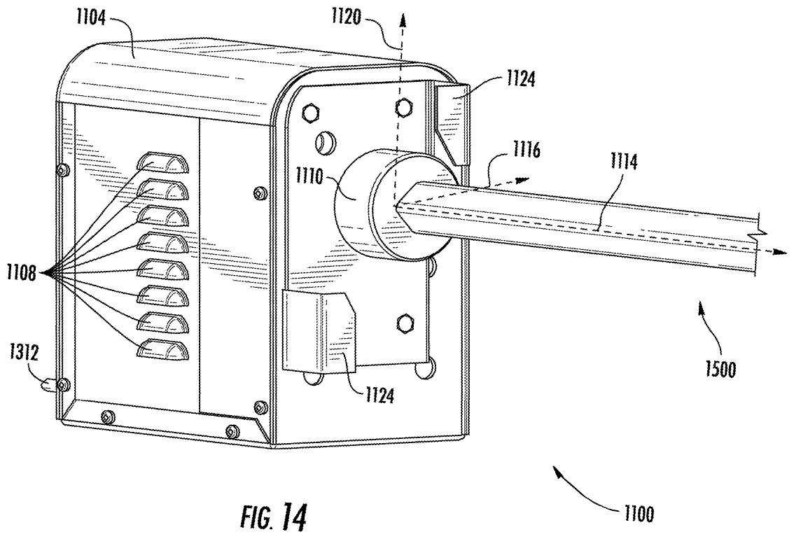

Referring now to FIGS. 11-14, the motor system 1100 can be partially defined by a housing 1104, a rotational axis (also referred to as a longitudinal axis) 1114, a lateral axis (also referred to as a first plane axis) 1116, and a vertical axis (also referred to as a second plane axis) 1120. The axes may define a first quadrant, a second quadrant, a third quadrant, and a fourth quadrant around the rotational axis 1114 in an order corresponding to a first direction of rotation about the rotational axis 1114. The housing 1104 may contain and protect the internal workings of the motor system 1100. As a result, the housing 1104 can be made with a large strength such as stainless steel, aluminum, zinc, or various alloys. The housing can include a plurality of exhausts 1108. The exhausts 1108 may allow the inner workings of the housing 1104 to exhaust to the exterior of the housing. The exhausts 1108 can be structured to transfer heat from inside the housing 1104 to the outside of the housing 1104. The exhausts 1108 can prevent the buildup of gases inside the housing.

Still referring to FIG. 11, the housing 1104 may include a receiver 1110. The receiver 1110 can receive a rotisserie spit and rotate the spit in the first direction of rotation about the rotational axis 1114. The receiver 1110 may extend from the housing 1104 along the rotational axis 1114. The receiver 1110 can include a triangular hole 1112 that may receive the rotisserie spit along the rotational axis 1114. The triangular hole 1112 may removably couple to a rotisserie spit. The receiver 1110 can receive rotisserie spits of various sizes (e.g., various shaft diameters or cross-sectional areas), such as by implementing several hole portions in the triangular hole 1112 having varying cross-sectional areas. The receiver 1110 can rotate the spit in the first direction of rotation about the rotational axis 1114, in order to properly cook food attached to the spit. The receiver 1110 may rotate the food at a certain speed such as a value between 4 and 6 rotations per minute. By rotating the food in a relatively slow speed, the food on the spit may be allowed to slowly and properly cook producing a thoroughly and evenly cooked food. The speed of the rotation may be adjustable. The speed can be adjustable between of value of 1 and 10 rotations per minute. The receiver 1110 may receive various other types of cooking spits. By using the triangular hole 1112, the backlash and other forces resisting movement along the first direction of rotation are minimized. The triangular hole 1112 has three points of connection, allowing for the backlash and other forces to be spread over the three contact points. This creates a lesser resistance. The triangular hole 1112 also allows for the spit to be received in three different orientations. This allows for multiple different configurations and easier receiving by the receiver 1110.

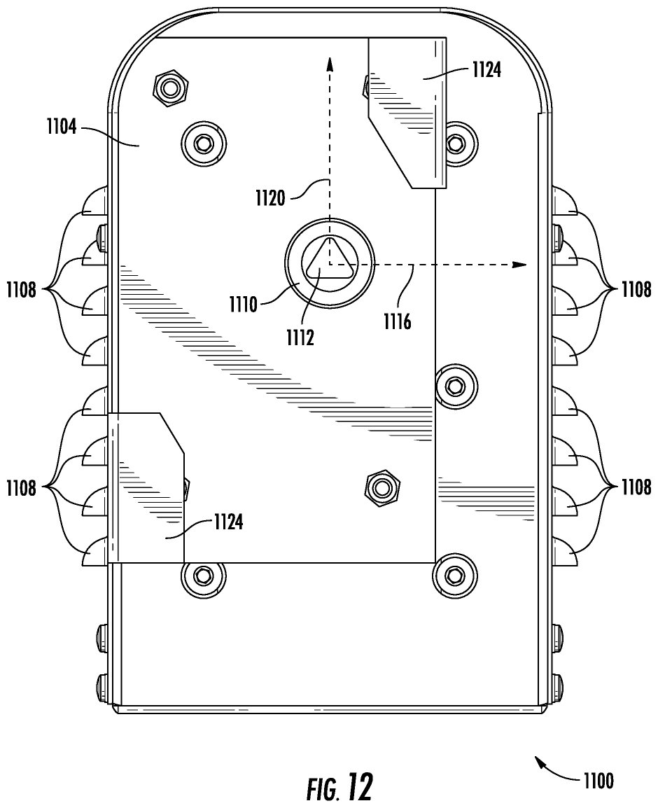

As best shown in FIG. 12, the motor system 1100 may include a pair of opposed brackets 1124. The brackets 1124 enable the housing 1104 to be side-loaded onto a support of the grill system 100, reducing the likelihood of hands of the user being exposed to the high temperatures of the heat source being used. The opposed brackets 1124 may be opposed along both the lateral axis 1116 and the vertical axis 1120. The opposed brackets 1124 may extend from the housing 1104 along the rotational axis 1114. The opposed brackets 1124 may be designed to attach to a steel beam or support such as the plurality of supports 604. When attached to the steel beam or support, the opposed brackets 1124 may be placed to provide stability to the motor system 1100. There may be a plurality of opposed brackets 1124, each bracket providing stability to the motor system 1100. The opposed brackets 1124 may be a part of a larger steel bracket that is coupled to the housing 1104. The opposed brackets 1124 provide a large advantage over other motor systems, in that they allow the motor system to be light and removable. In most motor systems, the motor system is fixedly coupled to the rotisserie and cannot be removed, which can lead to an expensive and largely immobile system that can be hard to move from place to place. As the opposed brackets 1124 allow the motor system 1100 to be attached to any rotisserie with a sizeable bracket or bar, the motor system 1100 can easily be removed and used with a variety of different rotisseries. When the use of the rotisserie is over, the motor system 1100 can easily be detached from the rotisserie and stored for later use. This allows the entire system to be much easier to move, operate, and setup.

The brackets 1124 may include a first bracket 1124 and a second bracket 1124. The first bracket 1124 may be located in the first quadrant and extending from the housing 1104 along the rotational axis 1114. The second bracket may be 1124 located in the third quadrant and extending from the housing 1104 along the rotational axis 1114. In FIG. 12, the first direction of rotation is clockwise rotation. Using this as an example, the first quadrant is the upper left of the housing 1104, the second quadrant is the upper right of the housing 1104, the third quadrant is the lower right of the housing 1104, and the fourth quadrant is the lower left of the housing 1104. By putting the first bracket 1124 and the second bracket 1124 in opposite quadrants, the brackets may better oppose motion. If the brackets were on the same side or directly across from one another, the motor system 1100 may be able to rotate and could cause damage to the first bracket 1124, second bracket 1124, or the motor system 1100.

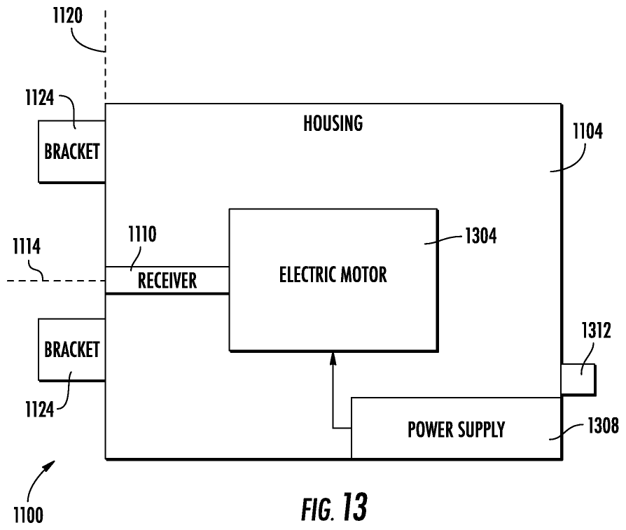

Referring now to FIG. 13, a block diagram of the motor system 1100 is shown. The block diagram shows a representation of the inner workings of the motor system 1100. The motor system 1100 may include an electric motor 1304. The electric motor 1304 may be any type of electric motor such as a brushless DC, a series wound, a shunt wound, a compound wound, a permanent magnet, or a three phase induction motor. The electric motor 1304 may be coupled to the receiver 1110 and rotate the receiver 1110 about the rotational axis 1114. The electric motor 1304 may rotate a spit attached to the receiver 1110 in a first direction of rotation about the rotational axis 1114, in order to properly cook food attached to the spit. The electric motor 1304 may rotate the receiver 1110 and the food at a certain speed such as a value between 4 and 6 rotations per minute. By rotating the food at a relatively slow speed, the food on the spit is allowed to slowly and properly cook producing a thoroughly and evenly cooked food. The speed of the rotation may be adjustable. The speed may be adjustable between of value of 1 and 10 rotations per minute.

The electric motor 1304 may be electrically coupled to and receive power from a power supply 1308. The power supply 1308 may provide power to the electric motor of the motor system 1100, which can allow the grill system 100 to be used away from areas in which electricity is readily available. The power supply 1308 may provide either AC or DC power. The power supply 1308 may be a wire that connects to another power supply outside of the housing 1208. The power supply 1308 may be a battery located inside of the housing 1208 that provides DC power. The power supply 1308 may be a battery that can operate the electric motor for 12 hours. The power supply 1308 may be charged by AC power received from a wall outlet.

The motor system 1100 can include a power switch 1312. The power switch 1312 may be coupled to the power supply 1308. When turned to the “on” position the power switch may allow power to flow to the electric motor 1304 and activate the motor system 1100. When turned to the “off” position the power switch 1312 may not allow power to flow to the electric motor 1304. There may be a controller that acts as an intermediary between the power switch 1312 and the power supply 1308, allowing power to flow when the power switch 1312 is on and not allowing power to flow when the power switch 1312 is off. The power switch 1312 may be a button that is “on” when the button is pressed in and “off” when the button is not pressed in. The power switch 1312 may be other types of power switches such as a turn dial or an adjustment knob.

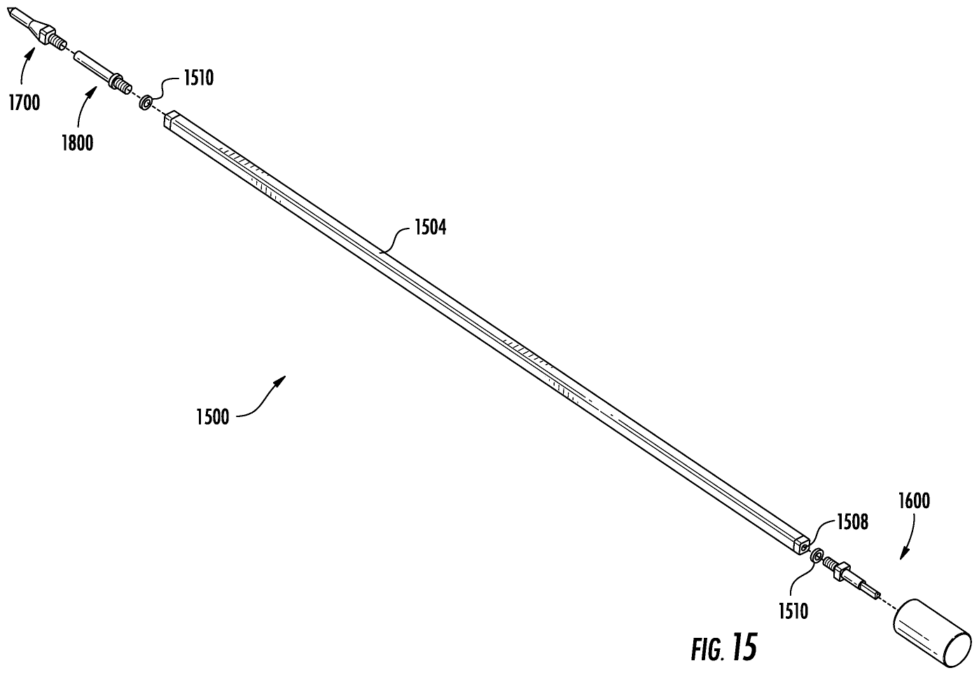

Referring now to FIGS. 15-18, the rotisserie spit kit 1500 can be versatile by including various components and adapters that can be readily coupled or decoupled from one another for different stages in the food preparation and cooking process (e.g., mounting the food onto the spit; transporting the spit and food to the grill; coupling the spit to the grill). The rotisserie spit kit 1500 includes a shaft 1504. The shaft 1504, as shown may be a long thin, metal shaft that extends from a first end to a second end. The shaft 1504 may be a square shaft (e.g. the perimeter of the shaft forms a square). The shaft 1504 may be a circular shaft. The shaft 1504 may be made out of a heat resistant metal such as steel, iron, nickel, or an alloy of one or more steels. The shaft 1504 may be heat resistant to prevent deformation during cooking, at which point temperatures can reach upwards of 1000° F. The shaft may contain a plurality of threaded holes 1508. The plurality of threaded holes 1508 receive threads and fasteners of various types. The threaded holes 1508 may be removably coupled to a threaded fastener. The threaded holes 1508 may be threadingly coupled to a threaded rotisserie spit tip or base. There may be two threaded holes 1508. There may be a threaded hole 1508 at each end of the shaft 1504. The threaded hole 1508 at the first end of the shaft 1504 may be a different size than the threaded hole 1508 at the second end of the shaft. There may be a single threaded hole 1508. The rotisserie may include a plurality of washers 1510. The washers 1510 may be located between the threaded holes 1508 and the end of any attachments that are threaded into the threaded holes 1508. The washer 1510 may protect the threaded holes 1508 from receiving damage. The rotisserie spit kit 1500 may include a prep tip 1700, a cooking tip 1800, and a base 1600.

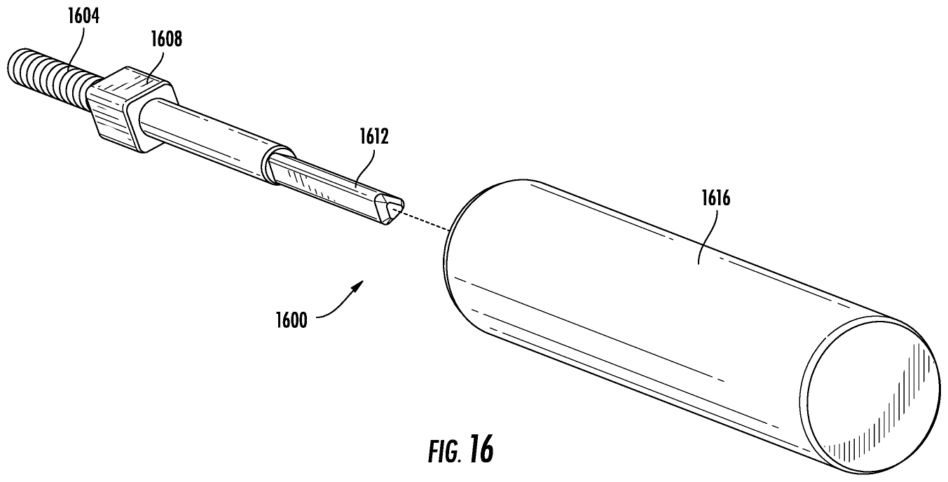

Referring to FIG. 16, the base 1600 is shown. The base 1600 may include a threaded portion 1604 (also referred to as a third end), a transitional portion 1608, a connecting coupling 1612 (also referred to as a fourth end), and an impact cover 1616. The base 1600 may extend from the threaded portion 1604 to the connecting coupling 1612. The threaded portion 1604 may be a threaded end such as that on the end of a threaded fastener. The threaded portion 1604 may be designed to easily fasten into a threaded receiver or holes such as the threaded holes 1508. The threaded portion 1604 may be sized to fit inside and removably couple to the threaded holes 1508. The threaded portion 1604 may removably couples with the shaft 1504 at a first end. The threaded portion 1604 may only fit inside a first threaded hole 1508 and not a second threaded hole 1508. The base 1600 may include an impact cover 1616. The impact cover 1616 may be designed to be removably coupled to the connecting coupling 1612 and may be used to receive, handle, and create an impact throughout both the base 1600 and the rotisserie spit kit 1500. The impact cover 1616 may be used to receive impacts to puncture food such as an animal carcass. The impact cover 1616 may have a larger diameter than the connecting coupling 1612, allowing the impact cover 1616 to removably couple with the connecting coupling 1612. In operation, the prep tip 1700 and the base 1600 may be removably coupled to the rotisserie spit kit 1500. The impact cover 1616 may be removably coupled to the base 1600. The prep tip 1700 may be pressed against a food such as an animal carcass and the impact cover 1616 may be impacted with a device such as a hammer. The impact travels may through the shaft 1504 and may be received by the animal carcass causing the prep tip 1700 to pierce the animal carcass. The impact cover 1616 may then be removed. The connecting coupling 1612 may be designed to removably couple with a rotisserie motor such as the motor system 1100 and the impact cover 1616. The connecting coupling 1612 may receive the bulk of a rotating force from the rotisserie motor and spin the rotisserie spit kit 1500 to cook the food supported by the rotisserie spit kit 1500. The coupling 1612 may be a triangular bar that is received by the triangular hole 1112. The coupling 1612 may removably couple with the triangular hole 1112. The transitional portion 1608 may be section of the base 1600 that transitions from the coupling 1612 to a square shaft similar in size to the shaft 1504.

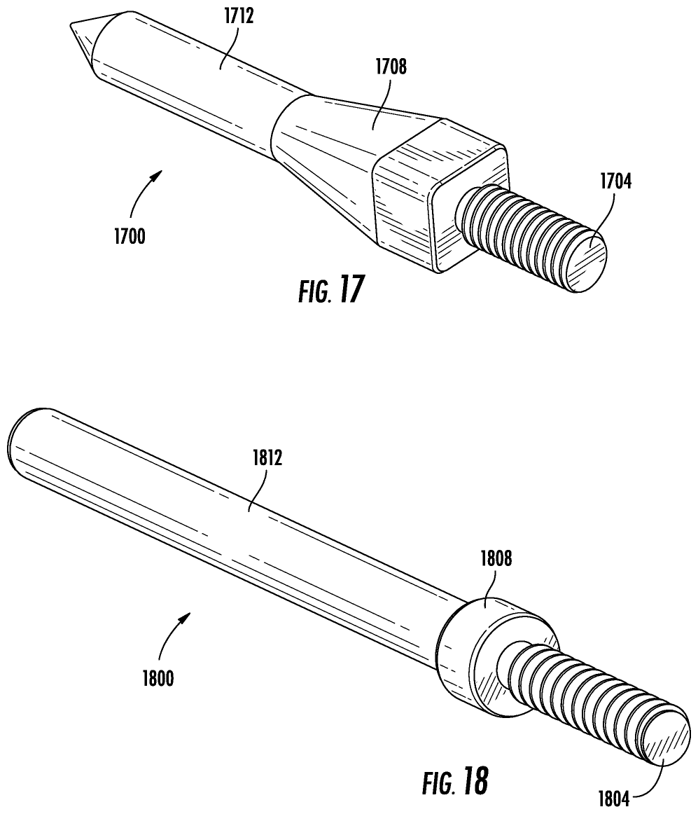

Turning now to FIG. 17, the prep tip (also referred to as a first tip) 1700 is shown. The prep tip 1700 may include threaded portion (also referred to as a fifth tip end) 1704, a transitional portion 1708, and a pointed edge (also referred to as a sixth tip end) 1712. The prep tip 1700 may extend from the threaded portion 1704 to the pointed edge 1712. The threaded portion 1704, may be a threaded end such as that on the end of a threaded fastener. The threaded portion 1704 may be designed to easily fasten into a threaded receiver or holes such as the threaded holes 1508. The threaded portion 1704 may be sized to fit inside and removably couple to the threaded holes 1508. The threaded portion 1704 may only fit inside a first threaded hole 1508 and not a second threaded hole 1508. The threaded portion 1704 may removably couple with the second end of the shaft 1504. The pointed edge 1712 may be a section of the prep tip 1700 that comes to a point. The pointed edge 1712 may be designed to puncture food. The pointed edge 1712 may be specifically designed to puncture animal carcasses and bone. The prep tip 1700 may include the transitional portion 1708. The transitional portion 1708 may be a section of the prep tip 1700 that transitions from the pointed edge 1712 to a square shaft similar in size to the shaft 1504. The threaded portion 1704, transitional portion 1708, and the pointed edge 1712 may be made of an antibacterial material such as stainless steel. In operation, the prep tip 1700 may be removably coupled to the rotisserie spit kit 1500, the pointed edge 1712 may be used to puncture food such as an animal carcass, the food slides over the transitional portion 1708 and onto the shaft 1504. The prep tip 1700 may then be removed from the rotisserie spit kit 1500.

Turning now to FIG. 18, the cooking tip (also referred to as a second tip) 1800 is shown. The prep tip 1800 may include a threaded portion 1804 (also referred to as a seventh tip end), a transitional portion 1808, and a blunt edge (also referred to as an eighth tip end) 1812. The cooking tip 1800 may extend from threaded portion 1804 to the blunt edge 1812. The threaded portion 1804 may be a threaded portion meant to be used with a fastener such as a threaded bolt. The threaded portion 1804 may be designed to easily fasten into a threaded receiver or holes such as the threaded holes 1508. The threaded portion 1804 may be sized to fit inside and removably couple to the threaded holes 1508. The threaded portion 1804 may only fit inside a first threaded hole 1508 and not a second threaded hole 1508. The threaded portion 1704 may be configured to removably couple with the second end of the shaft 1504. The blunt edge 1812, may be a section of the cooking tip 1800 that comes to a flat end. The blunt edge 1812 may be designed to be used during cooking of the food and is purposefully non-sharp. The blunt edge 1812 may have more surface area than the pointed edge 1712. As the blunt edge 1812 may be used during cooking, it is common for it to come into contact with a user. As a sharp edge can hurt the user, the blunt edge 1812 may be instead coupled to the rotisserie spit kit 1500 and used. The transitional portion 1808 may be section of the prep tip 1700 that transitions from the blunt edge 1712 to a circular shaft different in size to the shaft 1504. This may prevent food from easily sliding off of the shaft 1504 and onto the cooking tip 1800. The threaded portion 1804, transitional portion 1808, and the blunt edge 1812 may be made of an antibacterial material such as stainless steel. In operation, the cooking tip 1800 may be removably coupled to the rotisserie spit kit 1500 that is supporting food. The food may be cooked on the rotisserie spit kit 1500. The cooking tip 1800 and the food may then removed from the rotisserie spit kit 1500.

Because the rotisserie spit kit 1500 may include both a prep tip 1700 and the cooking tip 1800, the rotisserie spit kit 1500 may be both usable to cook with and to prepare animals for cooking. Often, a user has to prepare an animal and cook the animal using separate devices. Because the preparation of the animal requires a sharp utensil to pierce the animal or the bone of the animal, it may often be done with a specialized device. More so, a rotisserie spit often has a blunt edge so a user will not hurt themselves on the tip while cooking. The rotisserie spit kit 1500 instead includes both the prep tip 1700 and the cooking tip 1800 that are both removably coupled to the shaft 1504. Therefore, the prep tip 1700 can be used to pierce the animal, and the cooking tip 1800 can be used during cooking. The rotisserie spit kit 1500 can include various components, such as the prep tip 1700, cooking tip 1800, coupling 1612, or various combinations thereof, that may have various sizes (e.g., diameters, cross-sectional areas) for use in different modes of operation (e.g., small animal rotisserie, large animal rotisserie).

As the entire modular grill and rotisserie system 100 may be made of adjustable components such as the grill 200, the modular grill tables 900, the motor system 1100, and the rotisserie spit kit 1600, the grill and rotisserie system 100 may be better suited to operate in a variety of situations. The grill and rotisserie system 100 can operate as a small grill, a commercial grill, a rotisserie (e.g., small animal rotisserie, kebab, large animal rotisserie), and a weather-proof grill. The grill and rotisserie system 100 can be used off the grid (e.g., with portable power provided by a DC power source and DC motor of the motor system 1100). The grill and rotisserie system 100 may be entirely adjustable, the system may be easier than most grills and rotisseries to transport. The grill 200 can be adjusted to the non-extended configuration and can fit inside of a car along with the other components of the system 100. This allows the system 100 to be transported by a variety of vehicle sizes. More so, the system 100 has a large amount of modularity, allowing the user to adjust the system 100 as they see fit. This allows the user to create a grill system that works best for themselves at the time.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It should be appreciated that other elements of the various embodiments may be incorporated or utilized with any of the other embodiments disclosed herein.

What is claimed is:

1. A grill comprising:
a first base;
a first sidewall that extends from the first base;
a second base that receives the first base along a base axis;
a second sidewall that extends from the second base and receives the first sidewall along a sidewall axis, the sidewall axis is within five degrees of parallel to the base axis, the first sidewall and the second sidewall form a cavity above the first base and second base;
a rail receiver attached to at least one of the first base or the second base and opposite the cavity;
a rail that the rail receiver receives along a rail axis, the rail axis is within five degrees of parallel to each of the base axis and the sidewall axis;
a plurality of legs attached to at least one of the first base or the second base and opposite the cavity; and
at least one pole attached to a first leg of the plurality of legs,
wherein a force applied to the first sidewall causes the first base to move within the second base along the base axis, the first sidewall to move within the second sidewall along the sidewall axis, and the rail to move within the rail receiver along the rail axis.

2. The grill of claim 1, wherein the grill includes a plurality of supports that are removably coupled to at least one of the first sidewall or the second sidewall and include a plurality of slots for receiving a rotisserie spit.

3. The grill of claim 1, further comprising:
a pair of supports that each extend from a first support end removably coupled with the first sidewall or the second sidewall to a second support end, each support includes a plurality of slots for receiving a rotisserie spit; and
a roof that is coupled with the second support end of each of the pair of supports and is angled relative to the base axis.

4. The grill of claim 3, further comprising:
a first back panel removably coupled with the first sidewall; and
a second back panel that receives the first back panel, the second back panel removably coupled with the second sidewall.

5. The grill of claim 4, further comprising:
a first grate removably coupled with at least one of the first sidewall or the second sidewall and
a second grate removably coupled with at least one of the first sidewall or the second sidewall that receives the first grate along a grate axis, the grate axis is within five degrees of parallel to the base axis,
wherein the force applied to the first sidewall further causes the first grate to move within the second grate along the grate axis.

6. The grill of claim 5, wherein a cavity defined by the first sidewall, second sidewall, first base, and the second base, in a collapsed state, is sized to receive the pair of the supports, the first back panel, the second back panel, the first grate, and the second grate, in a collapsed state.

7. The grill of claim 1, wherein each leg of the plurality of legs is supported by a wheel.

8. The grill of claim 1, wherein the second base further includes an ash door that selectively moves between an open position and a closed position.

9. The grill of claim 1, wherein a first length defined along the first sidewall and the second sidewall is no greater than 35 inches in a first state and is at least 60 inches in a second state.

10. A motor system, comprising:
a housing comprising a receiver to receive a spit along a rotational axis;
an electric motor that rotates the receiver in a first direction of rotation about the rotational axis, the rotational axis defining a first plane axis perpendicular to the rotational axis, a second plane axis perpendicular to the rotational axis and the first plane axis, the first plane axis and second plane axis defining a first quadrant, a second quadrant, a third quadrant, and a fourth quadrant around the rotational axis in an order corresponding to the first direction of rotation;
a first bracket extending from the housing towards a second direction from which the spit is received, the first bracket located in the first quadrant; and
a second bracket extending from the housing towards the second direction, the second bracket location in the third quadrant.

11. The motor system of claim 10, wherein the first bracket includes a bracket extension that extends along the second direction and faces the first plane axis and is behind the first plane axis relative to the first direction of rotation when the first plane axis is aligned parallel to a gravity vector.

12. The motor system of claim 10, wherein when the motor system is activated, the brackets prevent the motor from spinning along the rotational axis to cause the receiver and the spit to rotate about the first direction of rotation.

13. The motor system of claim 10, wherein the electric motor is at least one of an alternating current (AC) electric motor powered by an AC power source or a direct current (DC) electric motor that is powered by a DC power source.

14. The motor system of claim 13, wherein the system further includes a battery, and the DC power source is the battery.

15. The motor system of claim 14, wherein the electric motor has an operating capacity of at least 10 hours.

16. The motor system of claim 10, wherein the receiver includes a triangular hole that receives an end of the spit.

17. A rotisserie spit kit, comprising:
a shaft extending from a first end to a second end;
a base extending from a third end configured to removably couple with first end of the shaft to a fourth end;
an impact cover configured to removably couple with the fourth end of the base, the impact cover having a greater diameter than the fourth end;
a first tip extending from a fifth tip end configured to removably couple with the second end of the shaft to a sixth tip end; and
a second tip extending from a seventh tip end configured to removably couple with the second end of the shaft to an eighth tip end, the eighth tip end is more blunt than the sixth tip end.

18. The rotisserie spit kit of claim 17, wherein the fifth tip end and seventh tip end threadingly couple with the second end of the shaft.

19. The rotisserie spit kit of claim 17, wherein the fourth end of the base couples with a motor.

20. The rotisserie spit kit of claim 17, wherein the eighth tip end has a greater surface area than the sixth tip end.
